(19) United States
(12) Patent Application Publication
(10) Pub. No.: US 2014/0244717 A1
(43) Pub. Date: Aug. 28, 2014

(54) EPORTAL SYSTEM AND METHOD OF USE THEREOF

(71) Applicant: MXN CORPORATION, Woodstock, GA (US)

(72) Inventors: George R. Patrick, Marietta, GA (US); Michael Lippman, Cartersville, GA (US); Bryan Moore, Flowery Branch, GA (US)

(73) Assignee: MXN Corporation, Woodstock, GA (US)

(21) Appl. No.: 13/779,228

(22) Filed: Feb. 27, 2013

(51) Int. Cl. H04L 29/06

(52) U.S. Cl. CPC H04L 67/42
USPC 709/203

(57) ABSTRACT

An eportal system that includes a server and a client device, wherein the client device preferably is not configurable by common users of the client device, and wherein the server includes an admin system that manages content that can be communicated over the eportal system, maintains a log of all activity, and also manages client devices and users utilizing those client devices.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The disclosure generally relates to computer networking, and more specifically to a system of networking and managing computer devices.

2. Description of Related Art

The disclosure relates generally to a system of networked computer devices and a method of using the same.

One previous approach was to use devices physically installed into students' desks, thus reducing the chances of damage to the devices. One disadvantage of this approach is that the devices could then only provide limited functionality to the students. Another disadvantage is that this did not save the students from having to carry around heavy books for all of their classes.

Another approach was to use a rugged laptop that has several modes of interaction, including an input device. A problem with this approach was that the devices did not adequately prevent users from using the devices within a limited set of available uses. Another problem is that these devices are more expensive and thus (1) there was an incentive for others to steal them, and (2) more money to replace.

Yet another approach was to use student devices that administer and monitor tests given to students. A problem with this approach was that the devices had limited functionality and did not do much more than centralize a testing scheme.

Therefore, it is readily apparent that there is a recognizable unmet need for a computer system with user devices that have broad but specifically restricted functionality, which allows for efficient communication both to and from users to administrators, and allows students/users to minimize how much material needs to be physically carried around, and is still inexpensive enough that there is less incentive for theft and the devices are easier to replace.

### SUMMARY

Briefly described, in a preferred embodiment, the present apparatus and method overcomes the above-mentioned disadvantages and meets the recognized need for such a system by providing a computer system with user devices that have broad but specifically restricted functionality, which allows for efficient communication both to and from users to administrators.

The present apparatus and method includes an eportal system with a server and a client device. In one embodiment, the client device is not configurable by common users of the client device, and the server includes an admin system that manages and logs all content.

According to its major aspects and broadly stated, the present disclosure describes an eportal system having a server, network communications, and a client device, with the client device and the server communicating via the network communications. The client device has a custom ROM and a custom browser. A user utilizing the client device is prevented from configuring or modifying the client device. The server has an Admin System and a datastore, the datastore having registration information, and the registration information relates to students' names, grade levels, and classes. The eportal system also has notifications, the notifications being sent from the server to the client device(s), and the notifications being messages, exams, content, and the like. The client device sends acknowledgement to the server in response to notifications, and the acknowledgement has response data that is stored in the datastore. Administrators, such as teachers, can access the response data, and this access includes reading and editing the response data.

The network communications coming from the client device(s) are forwarded to the server and filtered before, and if, they are permitted to enter the World Wide Web and/or other servers.

Utilizing the eportal system includes registering a client device, wherein the client device has a custom ROM, and users of the client device are prevented from modifying the client device. Another step is receiving network communications from the client device to a server, wherein the server has an Admin System and datastore. More steps include sending a notification with content from the server to the client device, sending acknowledgement from the client device to the server, the acknowledgment having response data, and storing the response data in the datastore. The client device has a browser and applications, and utilization also includes the step of filtering the network communications that are received by the server from the client device.

More specifically, the present disclosure of an embodiment is an eportal system, the eportal system having a client device, a server, at least one network, and notifications. The network includes known wireless networks and new wireless networks.

The client device includes a custom ROM, a browser, applications, and a unique portal number. The server includes an admin system, a datastore, registration information, individual login(s), response data, notification content, and acknowledgement(s).

In an exemplary embodiment, when a client device is turned on for the first time, the client device will receive information relating to possible schools and school districts that the client device will be used in. The user will then enter their name, student ID number, and school name. The server will then associate this information with the client device's unique portal number, which is within the custom ROM, and the client's devices MAC address. Thus, the server will be storing how to address this user individually, or as part of a group of people that includes this user.

In another embodiment, a school system sends a data file of students, student ID numbers, school attended, grade level, and any other relevant information, to the distributor of the client devices. This information is loaded into the server's datastore, and when the client device is turned on for the first time only the student's ID number need be entered, and from this piece of information the server can associate the client device with the correct student, school, grade, classes, or any other information that has been entered.

In one embodiment, the client devices are given a list of wireless networks that they are permitted to connect to, as well as the associated passwords, security, and any other information needed. In this embodiment, only administrators can enable client devices to connect to “new” wireless networks.

In another embodiment, common users of client devices are permitted to connect the client devices to any wireless network for which they have the appropriate information. In yet another embodiment, the ports or plugs that the client devices have preferably, although not necessarily, only allow charging of the client devices' battery, and not to add hard-drive space, share data, or install additional software.

In another embodiment, when the client device is registering, the client device queries the Admin System to see if registration information exists for the supplied student ID. If not, registration information is requested of the client device's user, and subsequently, assuming the entered information is correct and/or acceptable, the client device is registered with the registration information.

In one embodiment, notifications are generated by an administrator. The administrator decides on the recipients of the notification, and also decides what content the notification will include. The notification can include any type communication from the server to client devices, or vice versa, and can include, for exemplary purposes only and without limitation, messages, questions for a quiz or test, and content, including multimedia content or links to any of above, or the content may include such things as emergency and/or administrative type communications to teachers.

The administrator wishing to send a notification logs into the Admin System using their individual login. The administrator then creates a notification and chooses recipients of the notification. The notification is stored by the Admin System for retrieval by client devices by being stored in the datastore. Administrators may view notifications, acknowledgement of notifications, manage/delete notifications or acknowledgments. More specifically, administrators may view notifications sent to which device users, if and when any acknowledgements of those notifications were sent by client devices, and delete and/or amend the notifications and acknowledgments.

To receive notifications, client device(s) query the Admin System for new notifications at a fixed interval. However, it is contemplated herein that the notification may be communicated to client device(s) by being “pushed” to the client device. The device user receives the notification and either the client device itself sends an automatic acknowledgment, and/or the device user composes an acknowledgment, and that acknowledgment, which includes response data, is stored in the datastore. The response data is associated with the original notification, and the response data includes, for exemplary purposes only and without limitation, responses to the quiz or test that comprised the notification, a mere response that the notification has been read, such as “OK” or similar, and/or a text reply with substantive content.

It is contemplated herein that the described eportal system can be used in any similar situation, and the functionality can be applied in fields other than the educational field. For exemplary purposes only, and without limitation, the eportal system can also be used in the commercial field, wherein the users referred to as “students” may be employees of a company.

Accordingly, a feature of the ePortal system and method of use thereof is its ability to provide expanded functionality for users, such as, for exemplary purposes only, students.

Another feature of the ePortal system is its ability to prevent common users from negatively affecting performance of their devices.

Another feature of the ePortal system is its ability to easily allow communication to selected users.

Yet another feature of the ePortal system is its ability to monitor the results of these communications, and if they have been received and acknowledged.

Still another feature of the ePortal system is its ability to prevent users from acquiring unfiltered access to the World Wide Web.

Another feature of the ePortal system is its ability to allow for easy communications between superiors, such as teachers, and common users, such as students.

Another feature of the ePortal system is its ability to deliver content to the user, such as digital versions of text books eliminating the need to carry and/or transport such content.

Another feature of the ePortal system is its ability to enable communication between parent and teacher/administrator with regards to the device's assigned user, the student.

These and other features of the eportal system will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present fishing multi-cycle auto-disable device will be better understood by reading the Detailed Description with reference to the accompanying drawings, which are not necessarily drawn to scale, and in which like reference numerals denote similar structure and refer to like elements throughout, and in which:

FIG. 1 is a schematic view of a system for using an ePortal system in an exemplary embodiment;

FIG. 2A is a flowchart showing exemplary initial steps to register a device;

FIG. 2B is a flowchart showing exemplary initial steps to register a device;

FIG. 3A is a flowchart showing exemplary steps of how notifications are propagated;

FIG. 3B is a flowchart showing exemplary steps of how notifications are propagated;

FIG. 4 is a flowchart showing exemplary steps of how an ePortal device is used; and

FIG. 5 is a schematic view depicting the elements and relationships of notifications and network communications.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

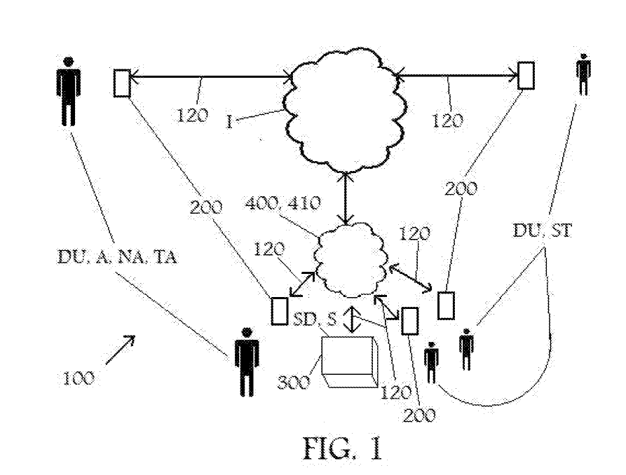

In describing the exemplary embodiments of the present disclosure, as illustrated in FIGS. 1-5, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-5 by way of example, and not limitation, therein is illustrated an eportal system 100, wherein eportal system 100 comprises device 200, server 300, network 400, and notifications 150, wherein network 400 comprises known wireless network 410 and new wireless network 420.

Device 200 comprises custom ROM 205, browser 210, applications 220, and unique portal number 240. Server 300 comprises Admin System 310, datastore 350, registration information 360, individual login 370, response data 381, notification content 382, and acknowledgement 383.

Eportal system 100, in an exemplary embodiment, can be used at schools S within school districts SD, wherein the device users DU comprise administrators A and students ST. Administrators A comprise network administrator NA and teacher administrators TA, wherein teacher administrators comprise class TC. Students ST comprise student ID SID and student grade level SG.

Turning more particularly, to FIG. 1, illustrated therein is a schematic view of a system for using an ePortal device in an exemplary embodiment. At school S, which is within school district SD, device users DU, such as administrators A and students ST, use devices 200 that are connected to known wireless network 410. Administrators A and students ST that are not physically located at school, can connect devices 200 via internet I. It is contemplated herein that in some embodiments, networks 400 may be wired networks, such as the connection between server 300 and the network 400.

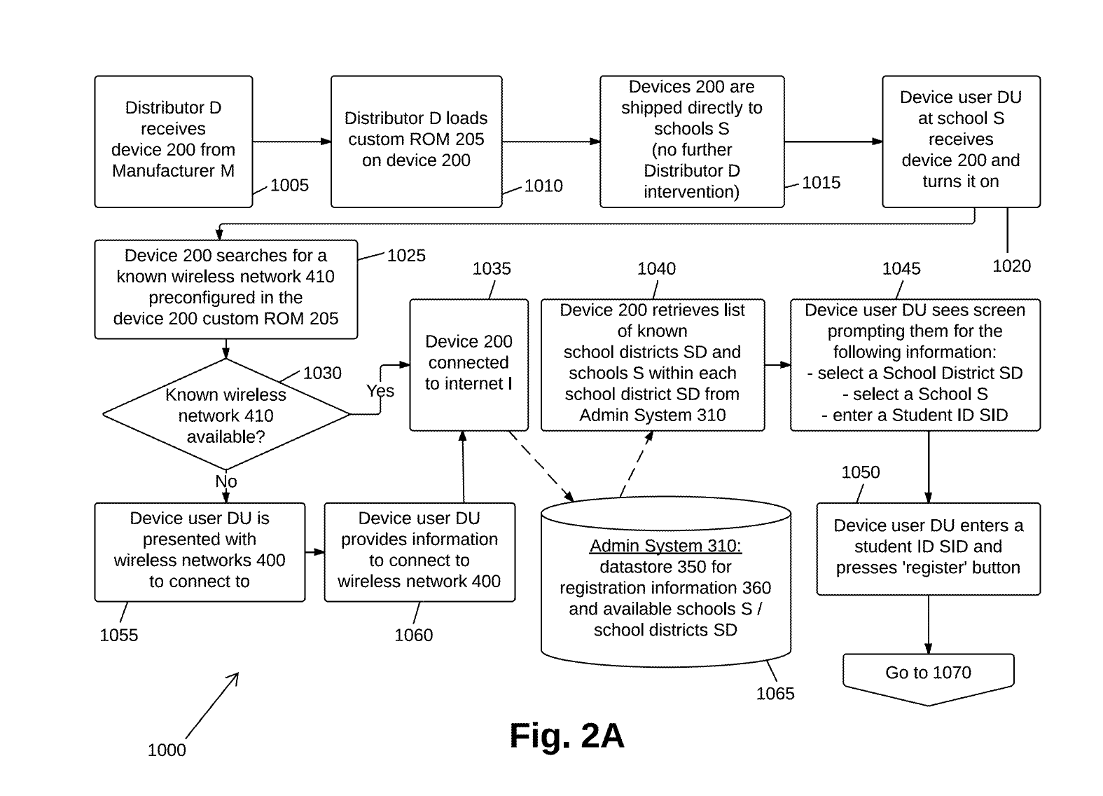

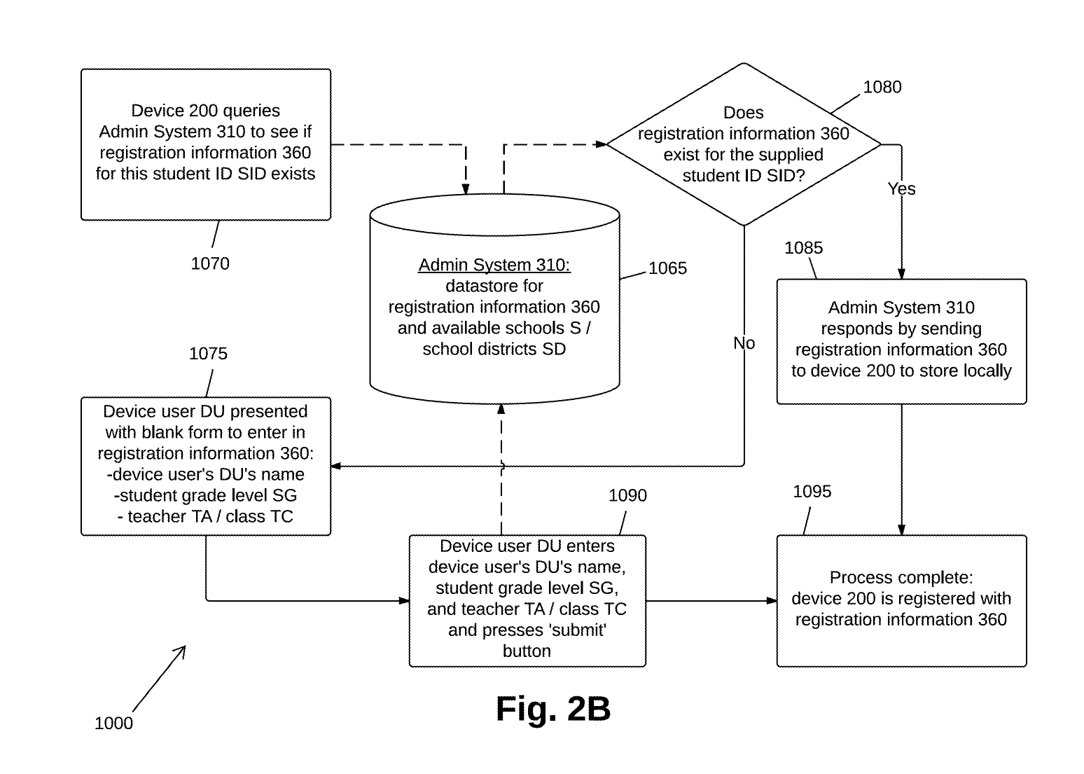

Turning now to FIGS. 2A and 2B, illustrated therein is a flowchart showing exemplary initial steps 1000 to register a device. Via step 1005 distributor D receives device 200 from manufacturer M. Next, via step 1010, distributor loads custom ROM 205 on device 200. In one embodiment, custom ROM 205 locks device 200 down to prevent anyone other than network administrator NA from configuring device 200, wherein said configuring includes, for exemplary purposes only, installing new software, installing new hardware, and using device's 200 ports for anything other than charging the battery. However, it will be recognized that custom ROM 205 may prevent anyone, including network administrator NA, from configuring device 200.

Via step 1015, devices 200 are shipped to schools S, and in this embodiment no further intervention by distributor D happens. Via step 1020, device user DU at school S receives device 200 and turns device 200 on, wherein device user DU at this step is administrator A. Device 200 searches for known wireless network 410 preconfigured in the device 200 custom ROM 205, via step 1025. At step 1030, device 200 determines if known wireless network 410 is available. If known wireless network 410 is available, device 200 connects to internet I via step 1035, wherein internet I at step 1035 is connected to known wireless network 410. If known wireless network 410 is not available, device user DU is presented network 400, which presumably includes new wireless networks 420, via step 1055. Via step 1060, device user DU provides information to connect to network 400, and proceeds to step 1035. Via step 1040, device 200 retrieves school district SD and school(s) S within school district SD from Admin System 310, wherein Admin System 310 is running on server 300, via 1065. Via step 1045, device user DU is prompted for school district SD, school S, and student ID SID, which are entered via step 1050.

Turning more particularly to FIG. 2B, via step 1070, device 200 queries Admin System 310 to see if registration information 360 exists for student ID SID. Via step 1080, if registration information 360 exists for supplied student ID SID, process proceeds to step 1085; otherwise, process proceeds to step 1075. Via step 1075, device user DU is asked for registration information 360, which comprises device user's DU's name, student grade level SG, and teacher TA and/or class TC, wherein the name entered is consistent with student ST associated with entered student ID SID. Via step 1090, registration information 360 requested via step 1075 is submitted, and subsequently device 200 is registered with registration information 360 via step 1095. Going back to step 1085, Admin System 310 sends registration information 360 to device 200.

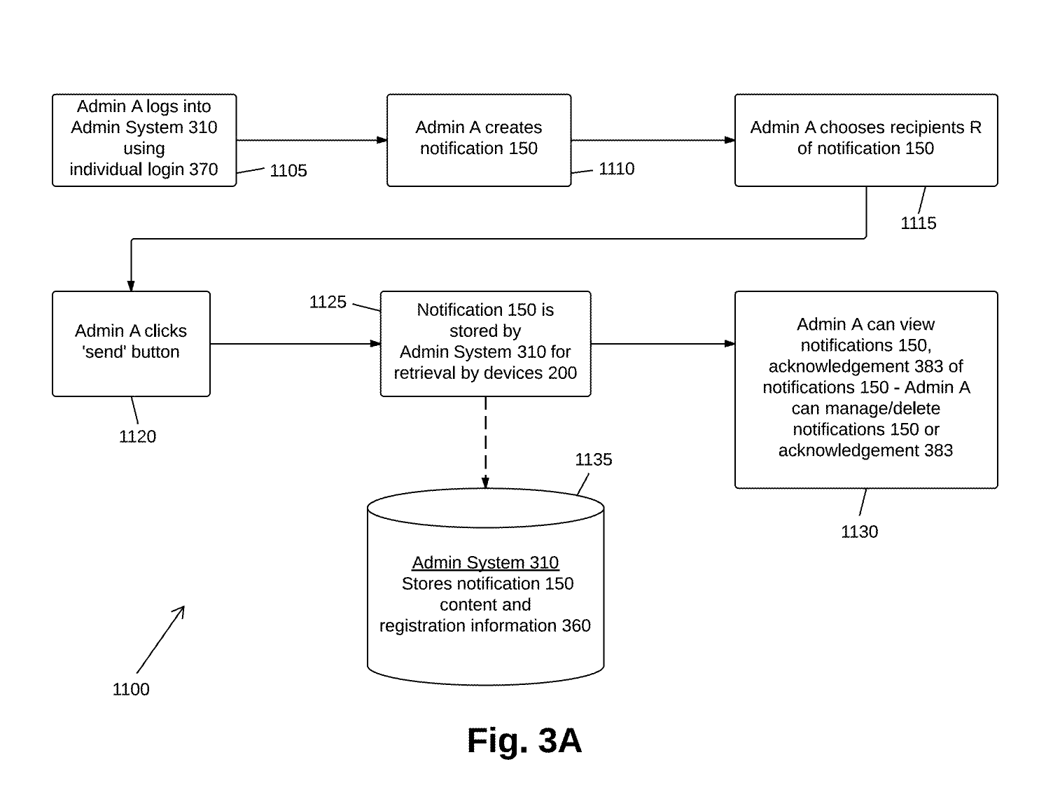

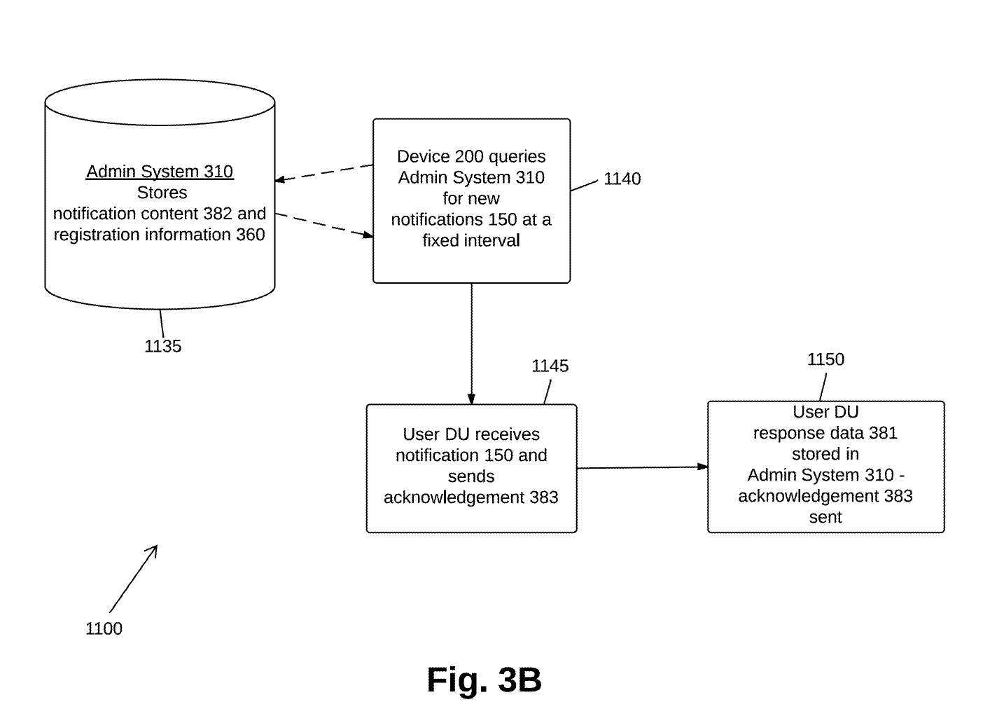

Turning now to FIGS. 3A and 3B, illustrated therein is a flowchart showing exemplary steps of how notifications are propagated 1100. It is contemplated and noted herein that those skilled in the art are familiar with the shorthand terminology “admin”, which can be used to refer to administrators A. Notification 150 comprises any type communication from server 300 to devices 200, or vice versa, including, for exemplary purposes only and without limitation, messages, questions for a quiz or test, and content, including multimedia content or links to any of above, wherein content may further include such things as emergency and/or administrative type communications to teachers. Further, notification 150 can be directed to recipients R, including, for exemplary purposes only and without limitation, all device users DU at school district SD, all users at school S, all students ST of a specific teacher administrator TA, all students ST of a certain class TC, wherein class TC describes either a subject or a expected graduating year, a single student ST, any device user DU, or any customized subgroup of above, supergroup of above, or combination thereof. For example, it is contemplated herein that notification 150 could be sent to all teachers TA during the school day that inclement weather is approaching and the students ST need to be moved to a safer location, or notification 150 could be sent to all teachers TA of certain student grade levels SG that a planned presentation has been canceled.

Via step 1105 administrator A logs into Admin System 310 using individual login 370, wherein individual login 370 is associated with the specific administrator A. Via step 1110, administrator A creates notification 150. Administrator A chooses recipients R of notification 150, via step 1120. Via step 1125, notification 150 is stored by Admin System 310 for retrieval by devices 200, wherein notification 150 is stored in datastore 350 on server 300. Via step 1130, administrator A may view notifications 150, acknowledgement 383 of notifications 150, manage/delete notifications 150 or acknowledgments 383. More particularly, via step 1130, administrators A may view notifications 383 sent to which device users DU, if and when acknowledgements 383 of those notifications 150 was sent by devices 200, and delete and/or amend notifications 383 and acknowledgments 383.

Turning more particularly to FIG. 3B, via step 1140, device 200 queries Admin System 310 for new notifications 150 at a fixed interval. However, it is contemplated herein that notification 150 may be communicated to device 200 by being “pushed” to device 200, as such term is understood in the telecommunications arts. Via step 1145, device user DU receives notification 150 and sends acknowledgments 383, and subsequently, via step 1150, response data 381 from device user DU is stored in Admin System 310 in datastore 350.

After recipient R, who is user U of device 200, reads notification 150, acknowledgement 383 is sent to server 300, wherein acknowledgement 383 becomes response data 381, which is associated with original notification 150, and wherein response data 381 comprises, for exemplary purposes only and without limitation, responses to the quiz or test that comprised the notification 150, a mere response that notification 150 has been read, such as “OK” or similar, and/or a text reply with substantive content.

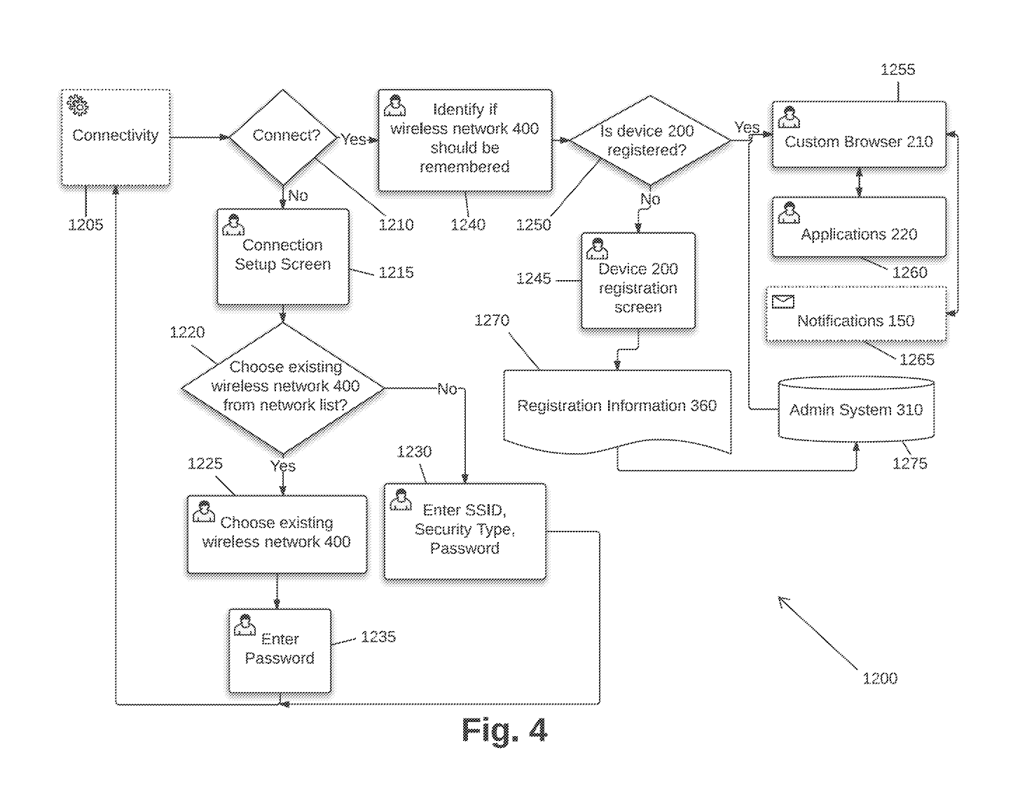

Turning now to FIG. 4, illustrated therein is a flowchart showing exemplary steps of how an ePortal device may be used 1200. Process 1200 starts via step 1205 and proceeds to step 1210, wherein device 200 attempts to connect to Admin Server 310. If device 200 can connect, device user DU identifies if network 400 should be remembered via step 1240, and then process 1200 proceeds to step 1250. If not, a connection setup screen is shown via step 1215, and via step 1220 device user DU decides whether to choose from an existing network 400 broadcasting its presence. If not, via step 1230 the correct login information is entered, which is typically, although not necessarily, the SSID, security type, and password for network 400. If an existing network 400 is selected, such happens via step 1225, and via step 1230 the appropriate login information is entered for network 400.

Going back to step 1250, if device 200 is registered with Admin System 310, process 1200 proceeds to step 1255. If not, device 200 registration screen allows entering of registration information 360 via step 1270, which is then communicated to Admin System 310 via step 1275.

Subsequently, via step 1255, device 200 is used as designed. With the embodiment described in FIG. 4, such use comprises using custom browser 210 via step 1255, interacting with and seeing notifications 150 via step 1265, and using applications 220 via step 1260. It is contemplated herein that applications 220 comprise such computer software as, for exemplary purpose only and without limitation, calculators, an internet browser, and test or quiz taking software.

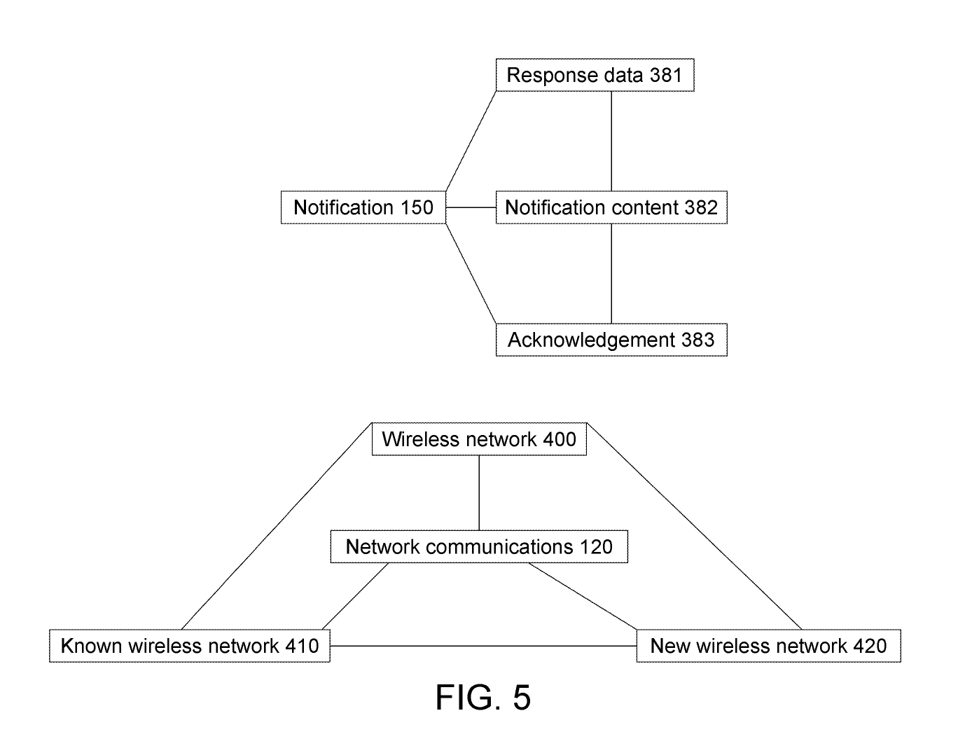

Turning now to FIG. 5, notification 150 relates to response data 381, notification content 382, and acknowledgement 383, which themselves are all related to each other.

It is contemplated herein that eportal system 100 can be used in any similar situation, and the functionality can be applied in fields other than the educational field. For exemplary purposes only, and without limitation, eportal system 100 can also be used in the commercial field, wherein students SD comprise employees.

It is further contemplated herein that network communications 120 from device 200 are routed through server 300, wherein server 300 thus manages what network communications 120 device 200 is allowed to conduct, and wherein said routing is accomplished through the device 200 treating server 300 as a proxy for network communications 120. In an alternate embodiment, device 200 creates a Virtual Private Network (VPN) with server 300, through which all network communications 120 from/to device 200 are channeled. In another embodiment, network communications 120 are forwarded to an electronic device on network 400 on or connected to server 300, wherein that electronic device functions as a firewall and/or filtering mechanism for network communications 120. It is contemplated herein that any and/or all of these combinations could be combined as would be recognized by those skilled in the art.

In one embodiment, device 200 comprises a tablet computer, but it is contemplated herein that device 200 may comprise any electronic device, mobile or otherwise.

It is contemplated herein that custom ROM 205 comprises a specifically designed operating system (OS) that controls the operation of device 200.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. An eportal system for a user, said eportal system comprising:
a server;
a network communication; and
a client device, wherein said client device and said server communicate via said network communication, and wherein said client device comprises a custom browser, and wherein the user comprises a student, and wherein the student utilizes said client device, and wherein the student is prevented from modifying said client device.

2. The eportal system of claim 1, wherein said server comprises an Admin System and a datastore, and wherein said datastore comprises registration information, and wherein said registration information relates to the student's name, grade level, and class.

3. The eportal system of claim 2, wherein said eportal system further comprises a notification, and wherein said notification is sent from said server to said client device.

4. The eportal system of claim 3, wherein said notification comprises messages, exams, and content.

5. The eportal system of claim 4, wherein said client device sends acknowledgement to said server in response to said notification, and wherein said acknowledgement comprises response data.

6. The eportal system of claim 5, wherein said response data is stored in said datastore on said server.

7. The eportal system of claim 6, wherein the user further comprise a teacher, and wherein the teacher can access said response data, and wherein said access comprises reading and editing said response data.

8. The eportal system of claim 1, wherein said network communication coming from said client device is forwarded to said server.

9. The eportal system of claim 8, wherein said network communication is filtered by said server.

10. The eportal system of claim 7, wherein said network communication coming from said client device is forwarded to said server.

11. A method for managing an eportal system, wherein said method comprises:
registering a client device, wherein said client device comprises a custom ROM, and wherein a user of said client device is prevented from modifying said client device.

12. The method of claim 11, said method further comprising the step of:
receiving a network communication from said client device via a server, wherein said server comprises an Admin System and datastore.

13. The method of claim 12, said method further comprising the steps of:
sending a notification from said server to said client device, wherein said notification comprises notification content;
sending acknowledgement from said client device to said server, wherein said acknowledgment comprises response data; and
storing said response data in said datastore.

14. The method of claim 13, wherein said notification comprises an exam for the user of said client device.

15. The method of claim 13, wherein said client device comprises a browser and applications, said method further comprising the step of:
filtering said network communication received by said server from said client device.

16. An eportal system for a user, said eportal system comprising:
a server;
a network communication;
a client device, wherein said client device and said server communicate via said network communication, and wherein said client device comprises a custom browser, and wherein the user of said client device is prevented from modifying said client device; and
a notification, wherein said notification is sent from said server to said client device, and wherein said client device sends acknowledgement to said server in response to said notification, and wherein said acknowledgement comprises response data, and wherein said response data is stored on said server.

17. The eportal system of claim 16, wherein said notification comprises a message to the user of said client device, and wherein said response data can be accessed by an administrator user on said server.

18. The eportal system of claim 17, wherein said server comprises an Admin System and a datastore, and wherein said datastore comprises registration information, and wherein said registration information relates to the student's name, grade level, and class, and wherein said notification comprises messages, exams, and content.

19. The eportal system of claim 1, wherein said network communication coming from said client device is arc forwarded to said server, and wherein said network communication is filtered by said server.

20. The eportal system of claim 5, wherein the user further comprise a teacher, and wherein the teacher can access said response data, and wherein said access comprises reading and editing said response data.
